(19) United States
(12) Patent Application Publication
(10) Pub. No.: US 2025/0263960 A1
(43) Pub. Date: Aug. 21, 2025

(54) HINGE FOR MITIGATING FORCE TRANSFER

(71) Applicant: Rivian IP Holdings, LLC, Irvine, CA (US)

(72) Inventors: William Kirk ROBINSON, Newport Beach, CA (US); Spencer Todd MORGENFELD, Costa Mesa, CA (US)

(21) Appl. No.: 18/444,290

(22) Filed: Feb. 16, 2024

(51) Int. Cl. E05D 11/00; B62D 33/027; E05D 3/02; E05D 5/06; E05D 5/10

(52) U.S. Cl. CPC E05D 11/00; B62D 33/0273; E05D 3/02; E05D 5/062; E05D 5/10; E05D 2005/067; E05D 2005/102; E05D 2011/009; E05Y 2600/622; E05Y 2900/544

(57) ABSTRACT

Hinges for mitigating force transfer are disclosed. A hinge coupling a tailgate to a support structure of a vehicle includes a first portion, a second portion, and one or more crumple features. The second portion rotations relative to the first portion to move the tailgate between an open position and a closed position. The one or more crumple features cause a length of the hinge to be reduced when a threshold force is applied to the hinge while the tailgate is in the closed position.

### INTRODUCTION

Events that are external to a vehicle, such as a collision with another vehicle, can cause one or more components of the vehicle to interact in an unexpected manner. For example, in the event of a collision, forces applied to one vehicle component can be translated to one or more other vehicle components, resulting in damage to multiple vehicle components.

### SUMMARY OF THE INVENTION

The present disclosure relates to vehicles, and more specifically, to a hinge for mitigating force transfer.

In one or more embodiments, a vehicle is disclosed. The vehicle includes a support structure, a tailgate, and a hinge coupling the tailgate to the support structure. The hinge includes a first portion, a second portion, and one or more crumple features. The second portion rotates relative to the first portion to move the tailgate between an open position and a closed position. The one or more crumple features cause a length of the hinge to be reduced when a threshold force is applied to the hinge while the tailgate is in the closed position.

In one or more embodiments, a tailgate system is disclosed. The tailgate system includes a tailgate and a hinge configured to couple the tailgate to a support structure of a vehicle. The hinge includes a first portion, a second portion, and one or more crumple features. The second portion rotates relative to the first portion to move the tailgate between an open position and a closed position. The one or more crumple features are configured to reduce a transfer of a threshold force to the support structure when the threshold force is applied to the hinge while the tailgate is in the closed position.

In one or more embodiments, a hinge is disclosed. The hinge includes a first portion and a second portion. The first portion is configured to couple the hinge to a support structure of a vehicle. The second portion is configured to couple the hinge to a tailgate of the vehicle. The second portion is coupled to the first portion, and the second portion rotates relative to the first portion to move the tailgate between an open position and a closed position. At least one of the first portion or the second portion include one or more crumple features are configured to cause a length of the hinge to be reduced when a threshold force is applied to the hinge.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting in scope, and may admit to other equally effective embodiments.

FIG. 1 illustrates an example vehicle, in accordance with embodiments of the present disclosure.

FIG. 2 illustrates a cross-sectional view of a tailgate in a closed position including a first portion and a second portion of a hinge, in accordance with embodiments of the present disclosure.

FIG. 3 illustrates an orientation of a hinge when a tailgate is in an open position, in accordance with embodiments of the present disclosure.

FIG. 4 illustrates a hinge extending a first distance beyond a rear bumper of a vehicle, in accordance with embodiments of the present disclosure.

FIG. 5 illustrates an example of a hinge having crumple features including one or more apertures and one or more pins configured to shear, in accordance with embodiments of the present disclosure.

FIG. 6 illustrates an example of a hinge having crumple features including an inner bore and one or more pins configured to shear, in accordance with embodiments of the present disclosure.

FIG. 7 illustrates an example of a crumple zone of a hinge, in accordance with embodiments of the present disclosure.

FIG. 8 illustrates an example of a crumpled hinge, in accordance with embodiments of the present disclosure.

FIG. 9 illustrates an example of a hinge having crumple features including a pin configured to shear, in accordance with embodiments of the present disclosure.

FIG. 10 illustrates an example of a hinge having a reduced length, in accordance with embodiments of the present disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

A vehicle with a tailgate includes a hinge that is coupled to the tailgate and also coupled to a portion of the vehicle. The hinge facilitates movement of the tailgate between a closed position and an open position. When the tailgate is in the closed position, a force applied to the hinge may be transferred to the portion of the vehicle to which the hinge is coupled, causing deformation of that portion of the vehicle and potentially requiring costly repairs. Certain embodiments described herein provide systems that mitigate transfer of the force to the portion of the vehicle.

In particular, embodiments herein describe a vehicle including a support structure, a tailgate, and a hinge coupling the tailgate to the support structure. In some embodiments, the hinge includes a first portion, a second portion, where one or both of the first portion and the second portion include one or more crumple features. The second portion can rotate relative to the first portion to move the tailgate between an open position and a closed position. In various embodiments, if the tailgate is in the closed position, the one or more crumple features cause a length of the hinge to be reduced when a threshold force is applied to the hinge. In certain embodiments, reducing the length of the hinge can mitigate transfer of the threshold force to the support structure.

Among other advantages, the embodiments described herein provide for forces to be applied to the hinge (e.g., in the event of a rear end collision) without substantial deformation of the support structure to which the hinge is coupled.

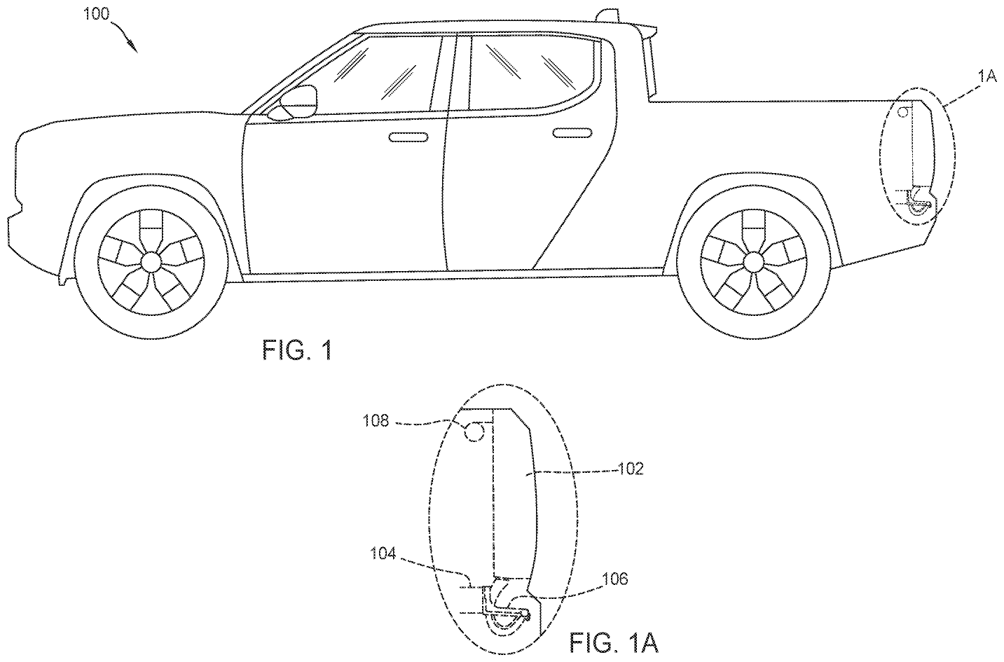

FIG. 1 illustrates an example vehicle 100, in accordance with embodiments of the present disclosure. Vehicle 100 is illustrated to include tailgate 102, support structure 104, and hinge 106 coupling tailgate 102 to support structure 104. Cable assembly 108 includes one or more cables with one end fixed to a portion of cable assembly 108 and the other end fixed to a portion of tailgate 102. In FIG. 1, tailgate 102 is illustrated in a closed position. In various embodiments, hinge 106 facilitates movement of tailgate 102 between the closed position and an open position. In the open position, one or more cables of cable assembly 108 may support tailgate 102 and objects/cargo resting on tailgate 102.

In some embodiments, hinge 106 may be manufactured from a variety of different materials, such as a polymer, stainless steel, aluminum alloy, titanium alloy, and/or the like. In one or more embodiments, hinge 106 can be manufactured from multiple different materials. In certain embodiments, hinge 106 may comprise a gooseneck hinge which is disposed below tailgate 102. In various embodiments, the gooseneck hinge has a wider range of motion relative to other types of hinges, which may facilitate a lower ending position of tailgate 102 (e.g., relative to a rear end bumper of vehicle 100) when tailgate 102 is in the open position. However, the techniques described herein may be implemented with any type of hinge or other vehicle component.

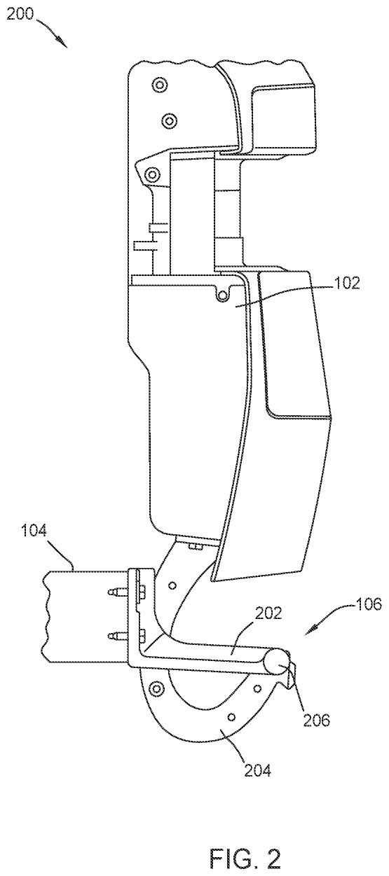

FIG. 2 illustrates a cross-sectional view of a tailgate 102 in a closed position 200 including a first portion 202 and a second portion 204 of a hinge 106, in accordance with embodiments of the present disclosure. As shown, first portion 202 is coupled to support structure 104, and second portion 204 is coupled to tailgate 102.

In one or more embodiments, first portion 202 and second portion 204 are connected by pivot joint 206. In some embodiments, second portion 204 rotates relative to first portion 202 about pivot joint 206 in a clockwise direction (as viewed in FIG. 2) to move tailgate 102 from closed position 200 to the open position. In some embodiments, second portion 204 rotates relative to first portion 202 about pivot joint 206 in a counter-clockwise direction (as viewed in FIG. 2) to move tailgate 102 from the open position to closed position 200.

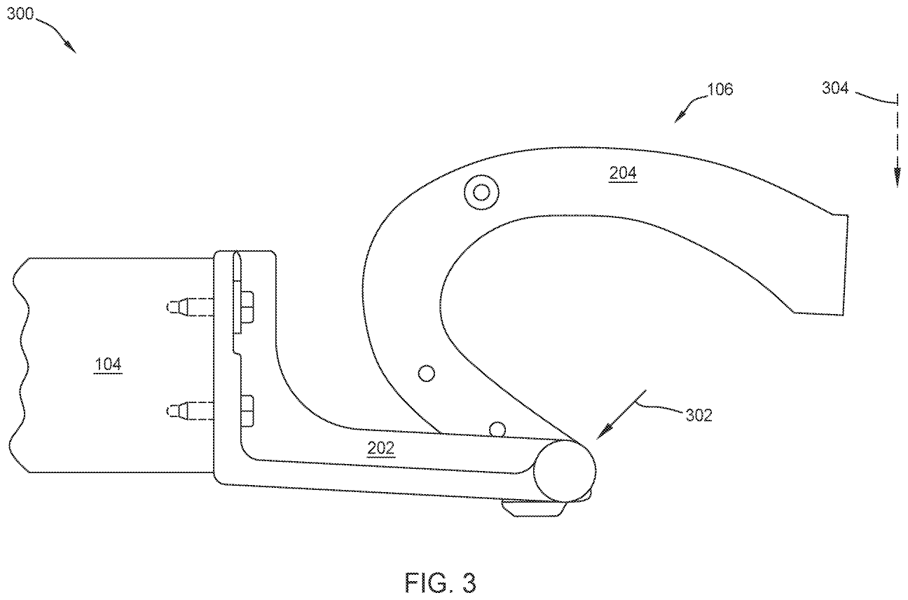

FIG. 3 illustrates an orientation 300 of a hinge 106 when a tailgate 102 is in an open position, in accordance with embodiments of the present disclosure. When tailgate 102 is in the open position, one or more cables of cable assembly 108 cause forces applied to tailgate 102 (e.g., by objects/cargo resting on tailgate 102) to be applied to first portion 202 of hinge 106 in a direction approximated by vector 302. For example, a force vector 304 applied to tailgate 102 (based on a mass of objects/cargo disposed on tailgate 102 when tailgate 102 is in the open position) is directed towards first portion 202 in the direction approximated by vector 302 by the one or more cables which connect tailgate 102 to vehicle 100.

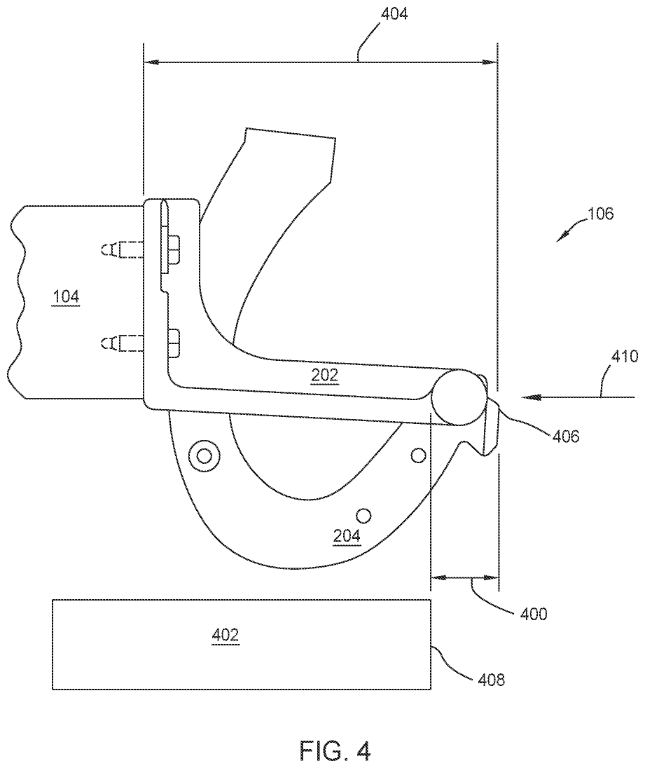

FIG. 4 illustrates a hinge 106 extending a first distance 400 beyond a rear bumper 402 of a vehicle 100, in accordance with embodiments of the present disclosure. In various embodiments, length 404 of hinge 106 extends beyond rear bumper 402 in a rearward direction such that rear portion 406 of hinge 106 extends beyond rear end 408 of rear bumper 402 by first distance 400. In some embodiments, force vector 410 is representative of a threshold force applied to hinge 106 when tailgate 102 is in closed position 200 (e.g., due to a rear end collision). Notably, since rear portion 406 of hinge 106 extends beyond rear end 408 of rear bumper 402, force vector 410 is applied to hinge 106 before force vector 410 is applied to, and at least partially absorbed by, rear bumper 402.

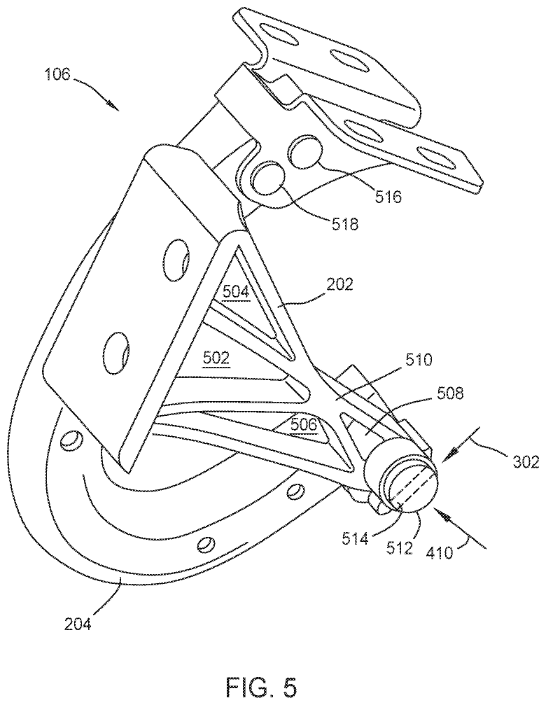

FIG. 5 illustrates an example of a hinge 106 having crumple features including one or more apertures 502, 504, 506, 508 and one or more pins 516, 518 configured to shear, in accordance with embodiments of the present disclosure. In some embodiments, apertures 502, 504, 506, 508 and solid portions of first portion 202 between apertures 502, 504, 506, 508 are configured to absorb and/or distribute kinetic energy in response to an application of force vector 410 to hinge 106 when tailgate 102 is in closed position 200. In certain embodiments, absorbing and/or distributing kinetic energy in response to the application of force vector 410 to hinge 106 may reduce a magnitude of force vector 410 that is transferred to another vehicle component by hinge 106, and can also cause hinge 106 to deform in a controlled and predictable manner. In one or more embodiments, when hinge 106 deforms in a controlled and predictable manner, length 404 of hinge 106 may be reduced by at least first distance 400 such that rear bumper 402 absorbs the remaining/reduced force of force vector 410.

In various embodiments, pivot pin 512 may be configured to shear in response to the application of force vector 410 to hinge 106 when tailgate 102 is in closed position 200. In some embodiments, pivot pin 512 may comprise asymmetric geometry 514. In one or more examples, when tailgate 102 is in the open position, asymmetric geometry 514 is reinforced such that applied forces to pivot pin 512 in the direction approximated by vector 302 are insufficient to cause shearing of pivot pin 512. In certain examples, when tailgate 102 is in closed position 200, asymmetric geometry 514 is not reinforced such that the application of force vector 410 to hinge 106 is sufficient/configured to shear pivot pin 512. In one or more embodiments, shearing pivot pin 512 may be configured to reduce length 404 by at least first distance 400 such that rear bumper 402 receives and absorbs force vector 410 (e.g., mitigating transfer of force vector 410 to support structure 104).

In certain embodiments, pins 516, 518 may be configured to shear in response to the application of force vector 410 to hinge 106 when tailgate 102 is in closed position 200. In some embodiments, shearing pins 516, 518 may be configured to reduce length 404 by at least first distance 400 such that rear bumper 402 receives and absorbs force vector 410. In various examples, receiving and absorbing force vector 410 by rear bumper 402 substantially reduces or prevents transfer of force vector 410 to support structure 104.

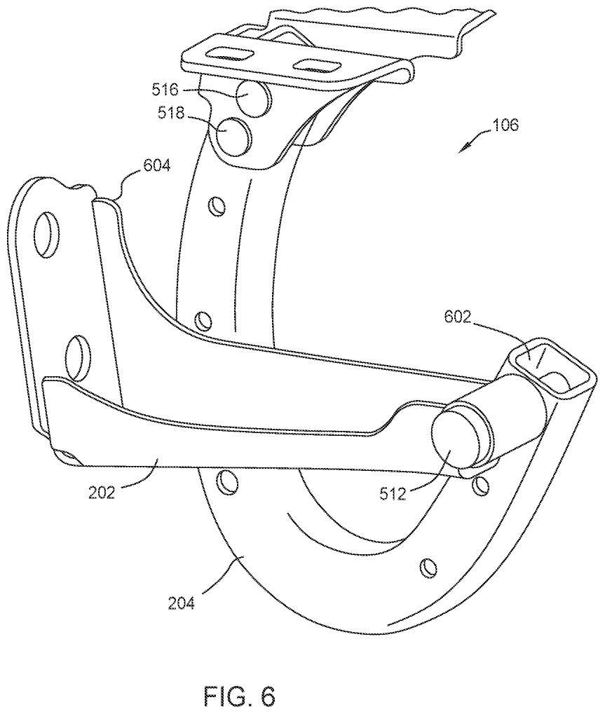

FIG. 6 illustrates an example of a hinge 106 having crumple features including an inner bore 602 and one or more pins 516, 518 configured to shear, in accordance with embodiments of the present disclosure. In certain embodiments, the presence of the hollow region defining inner bore 602 enables hinge 106 to absorb and/or distribute kinetic energy in response to an application of force vector 410 to hinge 106 (e.g., by causing hinge 106 to crumple) when tailgate 102 is in closed position 200. In various embodiments, absorbing and/or distributing kinetic energy in response to the application of force vector 410 to hinge 106 may reduce a magnitude of force vector 410 and also cause second portion 204 to deform in a controlled and predictable manner. In one or more embodiments, causing second portion 204 to deform in the controlled and predictable manner may be configured to reduce length 404 by at least first distance 400 such that rear bumper 402 absorbs the remaining/reduced force of force vector 410.

In some embodiments, stamped portion 604 may be configured to absorb and/or distribute kinetic energy in response to the application of force vector 410 to hinge 106 when tailgate 102 is in closed position 200. In various examples, stamped portion 604 can be manufactured using a stamping process or another manufacturing process (e.g., additive manufacturing, machining, etc.). In one or more examples, stamped portion 604 can be configured to fold/buckle in response to the application of force vector 410 to hinge 106 when tailgate 102 is in closed position 200. In certain embodiments, a folding/buckling of stamped portion 604 may be configured to reduce length 404 by at least first distance 400 such that rear bumper 402 receives and absorbs force vector 410. However, due to the upward-facing orientation of the hollow region of inner bore 602, first portion 202 is able to withstand significant forces applied in the direction approximated by vector 302 (e.g., due to a load applied to tailgate 102 when tailgate 102 is in the open position) without crumpling.

In various embodiments, pins 516, 518 may be configured to shear in response to the application of force vector 410 to hinge 106 when tailgate 102 is in closed position 200 in addition or alternative to stamped portion 604 being configured to fold/buckle in response to the application of force vector 410 to hinge 106 when tailgate 102 is in closed position 200. In one or more examples, shearing pins 516, 518 can be configured to cause stamped portion 604 to fold/buckle. In some examples, folding/buckling of stamped portion 604 may be configured to cause pins 516, 518 to shear.

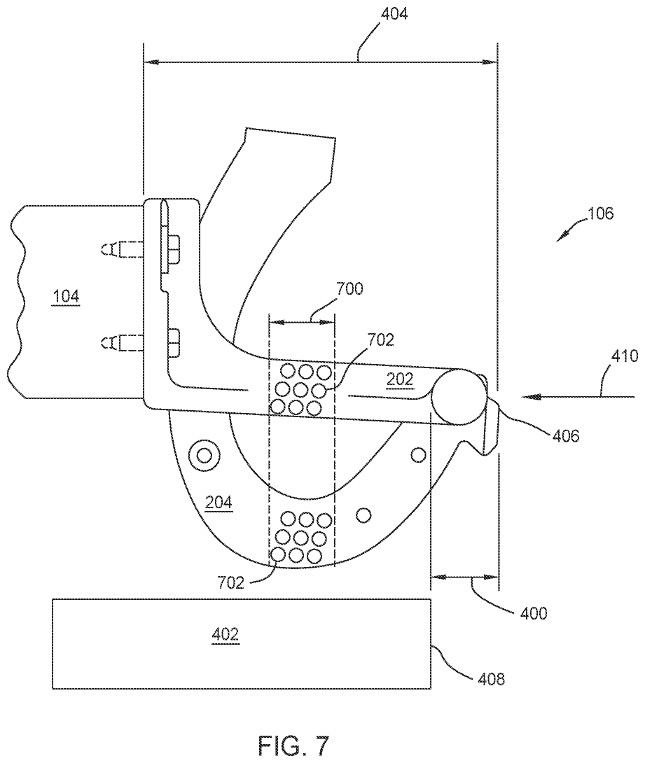

FIG. 7 illustrates an example of a crumple zone 700 of a hinge 106, in accordance with embodiments of the present disclosure. In one or more embodiments, crumple zone 700 includes multiple apertures 702. As shown in FIG. 7, crumple zone 700 is included in both first portion 202 and second portion 204 of hinge 106. In various embodiments, multiple apertures 702 are configured to cause crumple zone 700 to crumple in response to an application of force vector 410 to hinge 106 when tailgate 102 is in closed position 200.

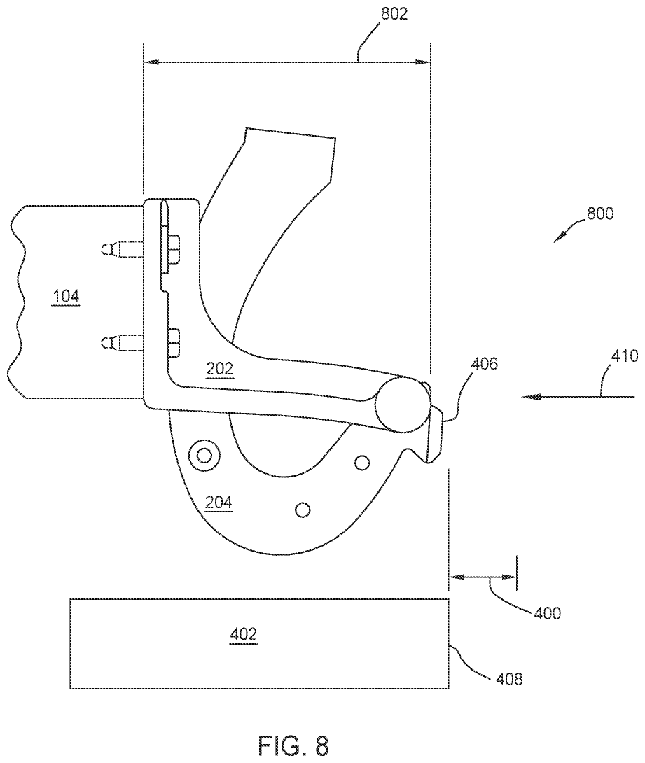

FIG. 8 illustrates an example of a crumpled hinge 800, in accordance with embodiments of the present disclosure. As shown, an application of force vector 410 to hinge 106 when tailgate 102 is in closed position 200 causes crumple zone 700 to crumple and compresses hinge 106 into crumpled hinge 800 in some examples. In certain embodiments, length 404 is reduced by at least first distance 400 to reduced length 802 such that rear bumper 402 receives and absorbs force vector 410. Since rear bumper 402 receives and absorbs force vector 410, a magnitude of force vector 410 transferred to support structure 104 is minimal and insufficient to significantly deform support structure 104.

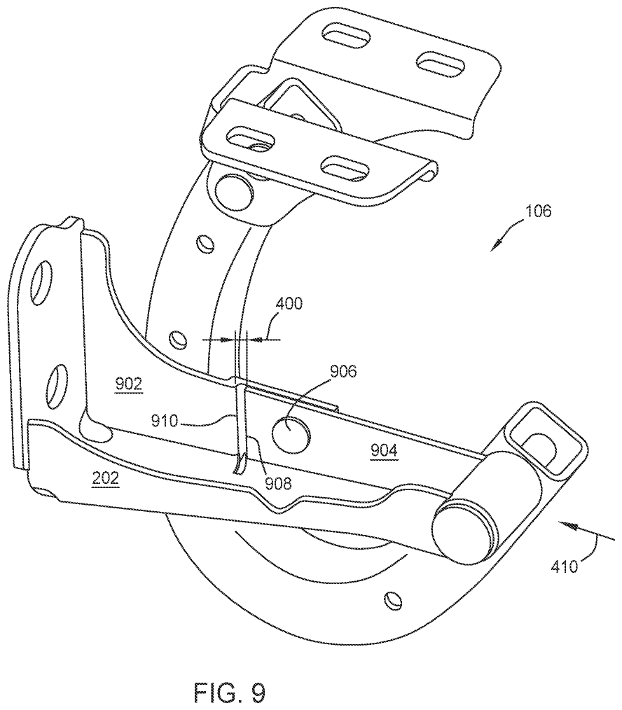

FIG. 9 illustrates an example of a hinge 106 having crumple features including a pin 906 configured to shear, in accordance with embodiments of the present disclosure.

In some embodiments, first portion 202 includes front component 902 and rear component 904 which may be coupled together by pin 906. As shown, front end 908 of rear component 904 is separated from interface 910 of front component 902 by at least first distance 400. In certain embodiments, pin 906 may be configured to shear in response to the application of force vector 410 to hinge 106 when tailgate 102 is in closed position 200. In one or more embodiments, shearing pin 906 may be configured to reduce length 404 by at least first distance 400 such that rear bumper 402 receives and absorbs force vector 410.

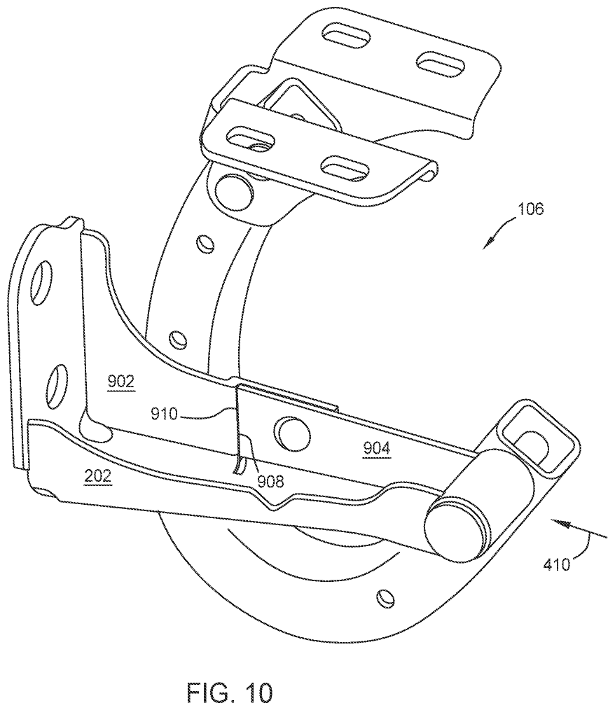

FIG. 10 illustrates an example of a hinge 106 having a reduced length 802, in accordance with embodiments of the present disclosure. In various embodiments, when pin 906 is sheared (e.g., in response to the application of force vector 410 to hinge 106), front component 902 and rear component 904 are no longer coupled together which allows front end 908 to actuate towards interface 910. In certain embodiments, when front end 908 contacts interface 910, length 404 is reduced by at least first distance 400 such that hinge 106 has reduced length 802 and rear bumper 402 receives and absorbs force vector 410. Because rear bumper 402 receives and absorbs force vector 410, the magnitude of force vector 410 transferred to support structure 104 is minimal and insufficient to significantly deform support structure 104.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially,” “approximately,” “generally,” and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an,” and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A vehicle, comprising:
a support structure;
a tailgate; and
a hinge coupling the tailgate to the support structure, the hinge comprising a first portion, a second portion, and one or more crumple features, wherein the second portion rotates relative to the first portion to move the tailgate between an open position and a closed position, and the one or more crumple features cause a length of the hinge to be reduced when a threshold force is applied to the hinge while the tailgate is in the closed position.

2. The vehicle of claim 1, wherein the first portion of the hinge is configured to receive the threshold force being applied to the hinge while the tailgate is in the closed position without substantial deformation of the support structure.

3. The vehicle of claim 2, further comprising a rear bumper, wherein, while the tailgate is in the closed position, the hinge extends a first distance beyond the rear bumper in a rearward direction, and the length of the hinge is reduced by at least the first distance in response to the threshold force.

4. The vehicle of claim 3, wherein the one or more crumple features comprise one or more crumple zones included in the first portion of the hinge.

5. The vehicle of claim 3, wherein the one or more crumple features comprise a pin coupling the first portion and the second portion, the pin configured to shear in response to the threshold force.

6. The vehicle of claim 3, wherein the one or more crumple features comprise an inner bore of the hinge.

7. The vehicle of claim 3, wherein the one or more crumple features comprise one or more apertures of the hinge.

8. The vehicle of claim 3, wherein the one or more crumple features comprise a pin coupling the second portion and the tailgate, the pin configured to shear in response to the threshold force.

9. The vehicle of claim 1, wherein the hinge comprises a gooseneck hinge.

10. A tailgate system comprising:
a tailgate; and
a hinge configured to couple the tailgate to a support structure of a vehicle, the hinge comprising a first portion, a second portion, and one or more crumple features, wherein the second portion rotates relative to the first portion to move the tailgate between an open position and a closed position, the one or more crumple features configured to reduce a transfer of a threshold force to the support structure when the threshold force is applied to the hinge while the tailgate is in the closed position.

11. The tailgate system of claim 10, wherein, while the tailgate is in the closed position, the hinge is configured to extend a first distance beyond a rear bumper of a vehicle in a rearward direction, and the one or more crumple features are configured to reduce a length of the hinge by at least the first distance in response to the threshold force.

12. The tailgate system of claim 10, wherein the one or more crumple features comprise an inner bore of the hinge.

13. The tailgate system of claim 10, wherein the one or more crumple features comprise one or more apertures of the hinge.

14. The tailgate system of claim 10, wherein the one or more crumple features comprise a pin configured to shear in response to the threshold force.

15. The tailgate system of claim 14, wherein the pin couples the second portion to at least one of the first portion or the tailgate.

16. A hinge comprising:
a first portion configured to couple the hinge to a support structure of a vehicle; and
a second portion configured to couple the hinge to a tailgate of the vehicle, the second portion coupled to the first portion, wherein the second portion rotates relative to the first portion to move the tailgate between an open position and a closed position, at least one of the first portion or the second portion comprising one or more crumple features configured to cause a length of the hinge to be reduced when a threshold force is applied to the hinge.

17. The hinge of claim 16, wherein the hinge comprises a gooseneck hinge.

18. The hinge of claim 16, wherein the one or more crumple features comprise an inner bore of the hinge.

19. The hinge of claim 16, wherein the one or more crumple features are further configured to reduce a transfer of the threshold force to the support structure of the vehicle.

20. The hinge of claim 16, wherein the one or more crumple features comprise a pin configured to shear in response to the threshold force.
